(19) United States
(12) Patent Application Publication
(10) Pub. No.: US 2025/0391297 A1
(43) Pub. Date: Dec. 25, 2025

(54) DISPLAY DEVICE, DRIVING METHOD THEREOF, AND AN ELECTRONIC DEVICE

(71) Applicant: Samsung Display Co., Ltd., Yongin-si (KR)

(72) Inventors: Jong Bin KIM, Yongin-si (KR); Bo Young AN, Yongin-si (KR)

(21) Appl. No.: 19/238,894

(22) Filed: Jun. 16, 2025

(30) Foreign Application Priority Data
Jun. 19, 2024 (KR) 10-2024-0079578
Aug. 5, 2024 (KR) 10-2024-0103903

(51) Int. Cl. G09G 3/00; G01K 3/00; G09G 3/3233

(52) U.S. Cl. CPC G09G 3/006; G01K 3/005; G09G 3/3233; G09G 2300/0842; G09G 2310/08; G09G 2330/027; G09G 2330/045; G09G 2330/10; G09G 2330/12

(57) ABSTRACT

A display device according to some embodiments of the present disclosure includes: pixels; a sensing unit configured to sense mobilities of the pixels during a sensing frame period; a temperature sensor configured to measure a current temperature; and an abnormality detector configured to determine whether the display device is abnormal based on the mobilities and powers off the display device based on an abnormality being detected, wherein the abnormality detector is configured to determine whether the display device is abnormal based on the current temperature and the mobilities during a first sensing frame period after a power-on sequence.

### CROSS-REFERENCE TO RELATED APPLICATION

The present application claims priority to and the benefit of Korean Patent Application Number 10-2024-0079578, filed on Jun. 19, 2024, and Korean Patent Application Number 10-2024-0103903, filed on Aug. 5, 2024, in the Korean Intellectual Property Office, the entire disclosures of each of which are incorporated herein by reference.

### BACKGROUND

### 1. Field

Aspects of some embodiments of the present disclosure described herein relate to a display device, a driving method thereof, and an electronic device.

### 2. Description of the Related Art

With the development of information technology, the importance of display devices, which are the connecting medium between users and information, is being highlighted. In response, the use of display devices such as liquid crystal display devices and organic light emitting display devices is increasing.

A display device includes a display panel for displaying an image, and the display panel includes a plurality of pixels. If the display panel is damaged and wiring inside the panel becomes short-circuited, it may cause a burnt or fire.

The information disclosed in this Background section is intended to enhance understanding of the background of the disclosure and therefore it may contain information that does not constitute prior art.

### SUMMARY

Aspects according to some embodiments of the present disclosure are directed toward a display device capable of quickly detecting whether there is an abnormality in the display device after a power-on sequence, a driving method thereof, and an electronic device.

A display device according to some embodiments of the present disclosure includes: pixels; a sensing unit configured to sense mobilities of the pixels during a sensing frame period; a temperature sensor configured to measure a current temperature; and an abnormality detector configured to determine whether the display device is abnormal based on the mobilities and configured to power off the display device when an abnormality is detected, wherein the abnormality detector is configured to determine whether the display device is abnormal based on the current temperature and the mobilities during a first sensing frame period after a power-on sequence.

According to some embodiments, the abnormality detector may be configured to determine whether the display device is abnormal based on difference values of the mobilities of a current sensing frame period and the mobilities of a previous sensing frame period, during sensing frame periods after the first sensing frame period.

According to some embodiments, the abnormality detector may include a mode determiner configured to determine whether the current sensing frame period corresponds to the first sensing frame period or a sensing frame period after the first sensing frame period.

According to some embodiments, the abnormality detector may further include a first threshold determiner configured to determine a first threshold based on a reference mobility, a reference temperature, and the current temperature, when the current sensing frame period corresponds to the first sensing frame period.

According to some embodiments, the abnormality detector may further include an abnormal pixel determiner configured to determine abnormal pixels among the pixels based on the first threshold and the mobilities of the first sensing frame period.

According to some embodiments, the abnormality detector may further include a power-off determiner configured to determine power-off of the display device when the number of the abnormal pixels is greater than a reference number.

According to some embodiments, the abnormality detector may further include a difference value acquirer configured to acquire difference values between the mobilities of the current sensing frame period and the mobilities of the previous sensing frame period, when the current sensing frame period corresponds to a sensing frame period after the first sensing frame period.

According to some embodiments, the abnormality detector may further include a candidate pixel determiner configured to determine pixels corresponding to the difference values greater than a reference difference value as candidate pixels.

According to some embodiments, the abnormal pixel determiner may determine the abnormal pixels among the candidate pixels based on the mobilities corresponding to the candidate pixels and a second threshold.

According to some embodiments, the abnormality detector may further include a second threshold determiner configured to determine the second threshold based on the reference mobility, the reference temperature, and the current temperature, when the current sensing frame period corresponds to a sensing frame period after the first sensing frame period.

A method of driving a display device according to one or more embodiments of the present disclosure includes: measuring a current temperature; sensing mobilities of pixels during a sensing frame period; determining whether the display device is abnormal based on the mobilities; and powering off the display device when an abnormality of the display device is detected, wherein whether the display device is determined to be abnormal is based on the current temperature and the mobilities during a first sensing frame period after a power-on sequence of the display device.

According to some embodiments, the display device may be configured to determine whether the display device is abnormal based on difference values of the mobilities of a current sensing frame period and the mobilities of a previous sensing frame period during sensing frame periods after the first sensing frame period.

According to some embodiments, the driving method may further include determining whether the current sensing frame period corresponds to the first sensing frame period or a sensing frame period after the first sensing frame period.

According to some embodiments, the driving method may further include determining a first threshold based on a reference mobility, a reference temperature, and the current temperature, when the current sensing frame period corresponds to the first sensing frame period.

According to some embodiments, the driving method may further include determining abnormal pixels among the pixels based on the first threshold and the mobilities of the first sensing frame period.

According to some embodiments, the operation method may further include determining power-off of the display device when the number of the abnormal pixels is greater than a reference number.

According to some embodiments, the driving method may further include acquiring difference values between the mobilities of the current sensing frame period and the mobilities of the previous sensing frame period, when the current sensing frame period corresponds to a sensing frame period after the first sensing frame period.

According to some embodiments, the driving method may further include determining pixels corresponding to the difference values greater than a reference difference value as candidate pixels.

According to some embodiments, the driving method may further include determining the abnormal pixels among the candidate pixels based on the mobilities corresponding to the candidate pixels and a second threshold.

An electronic device according to some embodiments of the present disclosure includes: a processor configured to provide an image data; and a display device configured to display an image based on the image data. The display device includes: pixels; a sensing unit configured to sense mobilities of the pixels during a sensing frame period; a temperature sensor configured to measure a current temperature; and an abnormality detector configured to determine whether the display device is abnormal based on the mobilities and configured to power off the display device based on an abnormality being detected. The abnormality detector is configured to determine whether the display device is abnormal based on the current temperature and the mobilities during a first sensing frame period after a power-on sequence.

According to some embodiments, the driving method may further include determining the second threshold based on the reference mobility, the reference temperature, and the current temperature, when the current sensing frame period corresponds to a sensing frame period after the first sensing frame period.

A display device, a driving method thereof, and an electronic device according to some embodiments of the present disclosure may relatively quickly detect whether there is an abnormality in the display device after a power-on sequence.

### BRIEF DESCRIPTION OF THE DRAWINGS

FIG. 1 is a drawing for illustrating a display device according to some embodiments of the present disclosure.

FIG. 2 is a drawing for illustrating a pixel and sensing channel according to some embodiments of the present disclosure.

FIG. 3 is a drawing for illustrating a display period according to some embodiments of the present disclosure.

FIG. 4 is a diagram for illustrating a mobility sensing period according to some embodiments of the present disclosure.

FIG. 5 is a diagram for illustrating periods of determining whether a display device is abnormal after a power-on sequence.

FIG. 6 is a diagram for illustrating an abnormality detector according to some embodiments of the present disclosure.

FIG. 7 is a diagram for illustrating a first threshold determiner according to some embodiments of the present disclosure.

FIG. 8 is a diagram for illustrating periods of determining whether the display device is abnormal after a power-on sequence according to aspects shown in FIG. 7.

FIG. 9 is a drawing for illustrating an abnormality detector according to some embodiments of the present disclosure.

FIG. 10 is a block diagram of an electronic device according to an embodiment.

FIGS. 11 to 13 shows schematic views of various embodiments of an electronic device.

### DETAILED DESCRIPTION

Hereinafter, referring to the accompanying drawings, some embodiments of the present disclosure are described in more detail so that a person skilled in the art to which the present disclosure pertains can more easily practice them. The present disclosure may be implemented in a number of different forms and is not limited to the embodiments described herein.

In order to clearly describe the present invention, parts irrelevant to the description are not provided, and the same reference numerals are given for the same or similar components throughout the specification. Therefore, reference numerals previously described may be used in other drawings as well.

In addition, the size and thickness of each configuration shown in the drawings are arbitrarily indicated for ease of explanation, so that the present disclosure is not necessarily limited to what is shown. Thicknesses may be exaggerated in order to clearly represent multiple layers and areas in the drawing.

Further, the expression “the same” or “identical” in the description may refer to “substantially the same” or “substantially identical”. In other words, this expression may indicate that two parts are so identical that a person skilled in the art would be convinced that they are identical. Other expressions may also be expressions from which the word “substantially” is not provided.

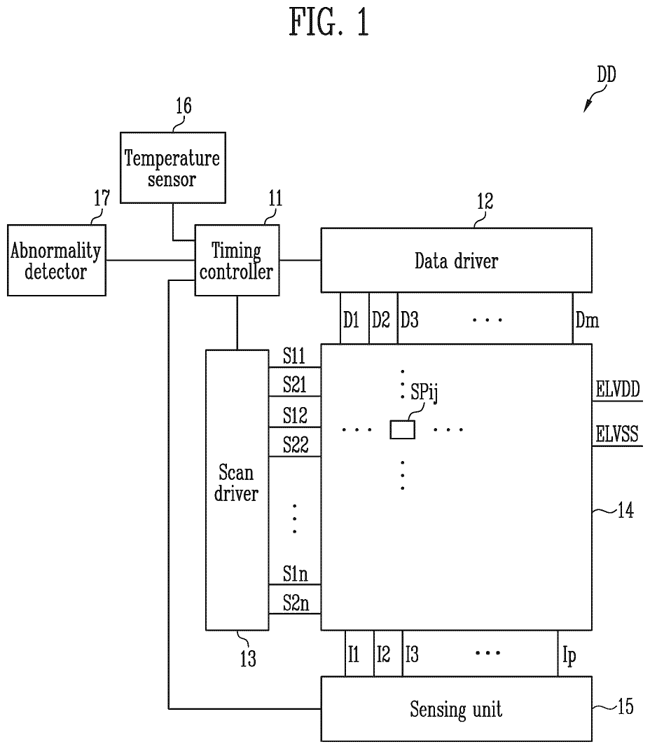

FIG. 1 is a drawing for illustrating a display device according to some embodiments of the present disclosure.

Referring to FIG. 1, a display device (DD) according to some embodiments of the present disclosure may include a timing controller 11, a data driver 12, a scan driver 13, a pixel unit 14, a sensing unit 15, a temperature sensor 16, and an abnormality detector 17.

The temperature sensor 16 may measure a current temperature. For example, the temperature sensor 16 may measure an ambient temperature of the display device (DD) and provide the measured ambient temperature as the current temperature.

The timing controller 11 may receive input gradations and control signals for each frame (e.g., image frame) from a processor. The processor may be at least one of a graphics processing unit (GPU), a central processing unit (CPU), or an application processor (AP).

The timing controller 11 may convert the input gradations to produce output gradations. Sensing data provided by the sensing unit 15 may be used for generation of the output gradations.

For example, the timing controller 11 may generate the output gradations by converting the input gradations using the sensing data provided by the sensing unit 15. Compensation using the sensing data may compensate for dispersion of electrical properties of pixel circuits. The sensing data may include a threshold voltage of a transistor, mobility of the transistor, a threshold voltage (or an operating voltage) of a light-emitting diode, and the like.

The timing controller 11 may provide the output gradations to the data driver 12. Further, the timing controller 11 may provide control signals suitable for the specifications of each of the data driver 12, the scan driver 13, the sensing unit 15, and the abnormality detector 17.

During a display period, the data driver 12 may generate data voltages to be provided to data lines (D1, D2, D3, . . . , Dm) using the output gradations and control signals received from the timing controller 11. For example, the data driver 12 may sample the output gradations using a clock signal and convert the sampled output gradations into data voltages. The data driver 12 may apply the data voltages to the data lines (D1˜Dm) per pixel row. Here, m may be an integer greater than zero (0). Here, the pixel row refers to pixels (or sub-pixels) which are connected to the same scanning lines. During a sensing period, the data driver 12 may supply reference voltages to the data lines (D1˜Dm).

The scan driver 13 may receive a clock signal, a scanning start signal, and the like, from the timing controller 11 and generate first scanning signals to be provided to first scanning lines (S11, S12, . . . , S1n) and second scanning signals to be provided to second scanning lines (S21, S22, . . . , S2n). Here, n may be an integer greater than zero (0).

For example, the scan driver 13 may sequentially supply the first scanning signals with turn-on level pulses to the first scanning lines (S11˜S1n). In addition, the scan driver 13 may sequentially supply the second scanning signals with turn-on level pulses to the second scanning lines (S21˜S2n). For example, the scan driver 13 may include a first scan driver connected to the first scanning lines (S11, S12, S1n) and a second scan driver connected to the second scanning lines (S21, S22, S2n). Each of the first scan driver and the second scan driver may include scanning stages configured in the form of a shift register. Each of the first scan driver and the second scan driver may generate scanning signals by sequentially transmitting the scanning start signal in the form of a turn-on level pulse to the next scanning stage according to control of the clock signal.

The pixel unit 14 includes pixels. Each pixel may include a first sub-pixel configured to emit light of a first color, a second sub-pixel configured to emit light of a second color, and a third sub-pixel configured to emit light of a third color. The first, second, and third colors may be different colors.

Each pixel (SPij) may be connected to a corresponding data line, scanning line, and sensing line. The pixels (or sub-pixels) may be connected to a common first power line (ELVDD) and a second power line (ELVSS). For example, during the display period, the voltage of the first power line (ELVDD) may be greater than that of the second power line (ELVSS).

During the display period, the sensing unit 15 may supply an initialization voltage to sensing lines (I1, I2, I3, . . . , Ip). Here, p may be an integer greater than zero (0). During the sensing period, the sensing unit 15 may receive sensing voltages from the sensing lines (I1˜IP) connected to the pixels (or sub-pixels).

The sensing unit 15 may include sensing channels connected to the sensing lines (I1˜IP). For example, the sensing lines (I1˜IP) and the sensing channels may correspond one-to-one. For example, the number of the sensing lines (I1˜IP) and the number of the sensing channels may be the same or equal to each other. In some embodiments, the number of the sensing channels may be less than the number of the sensing lines (I1˜IP). Here, the sensing unit 15 may be further provided with demultiplexers to perform sensing of the pixels (or sub-pixels) in a time-division manner.

The sensing unit 15 may sense mobilities of the pixels during a sensing frame period. For example, a period for sensing the mobilities of all pixels to be sensed of the pixel unit 14 once may be called one sensing frame period. In some embodiments, the pixels to be sensed may be all the pixels of the pixel unit 14. In some embodiments, the pixels to be sensed may be some pixels of the pixel unit 14.

The abnormality detector 17 may determine whether the display device (DD) is abnormal based on the mobilities, and if an abnormality is detected, the display device (DD) may be powered off.

According to some embodiments, at least two or more of the timing controller 11, the data driver 12, the scan driver 13, the pixel unit 14, the sensing unit 15, the temperature sensor 16, and the abnormality detector 17 may be configured as an integrated chip (IC). That is, an integrated chip (IC) may include at least two or more of the timing controller 11, the data driver 12, the scan driver 13, the pixel unit 14, the sensing unit 15, the temperature sensor 16, and the abnormality detector 17. Since separation or integration of respective functional units shown in FIG. 1 falls within the scope which can be easily changed by those skilled in the art, description of all cases is not provided.

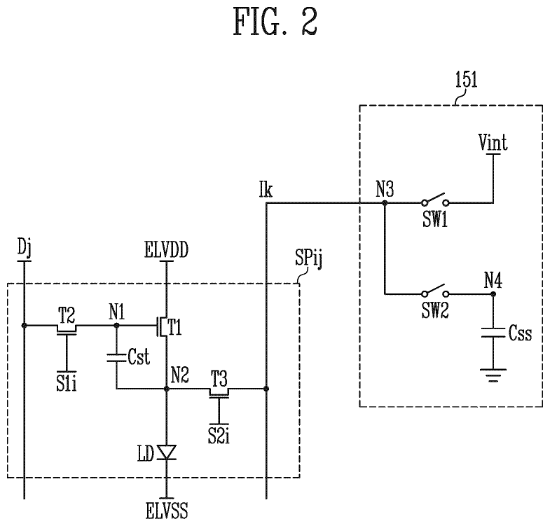

FIG. 2 is a drawing for illustrating a pixel and a sensing channel according to some embodiments of the present disclosure. Although FIG. 2 illustrates various components in a pixel and a sensing channel according to some embodiments, embodiments according to the present disclosure are not limited thereto, and according to various embodiments, the pixel and sensing channel may include additional components or fewer components without departing from the spirit and scope of embodiments according to the present disclosure.

The pixel (SPij) may include transistors (T1, T2, T3), a storage capacitor (Cst), and a light-emitting diode (LD).

The transistors (T1, T2, T3) may include N-type transistors. In some embodiments, the transistors (T1, T2, T3) may include P-type transistors. In some embodiments, the transistors (T1, T2, T3) may include (e.g., consist of) a combination of N-type transistors and P-type transistors. The P-type transistor may include a transistor in which the amount of current conducted increases when a voltage difference between its gate electrode and its source electrode increases in the negative direction. The N-type transistors may include a transistor in which the amount of current conducted increases when a voltage difference between its gate electrode and its source electrode increases in the positive direction. The transistors may be configured in one or more suitable forms, such as a thin film transistor (TFT), a field effect transistor (FET), and a bipolar junction transistor (BJT).

The first transistor (T1) may have a gate electrode connected to a first node (N1), a first electrode connected to the first power line (ELVDD), and a second electrode connected to a second node (N2). The first transistor (T1) may be a driving transistor.

The second transistor (T2) may have a gate electrode connected to the first scanning line (S1i), a first electrode connected to the data line (Dj), and a second electrode connected to the first node (N1). The second transistor (T2) may be a scan transistor.

The third transistor (T3) may have a gate electrode connected to the second scanning line (S2i), a first electrode connected to the second node (N2), and a second electrode connected to the sensing line (Ik). The third transistor (T3) may be a sensing transistor.

The storage capacitor (Cst) may have a first electrode connected to the first node (N1) and a second electrode connected to the second node (N2).

The light-emitting diode (LD) may have an anode connected to the second node (N2) and a cathode connected to the second power line (ELVSS). The light-emitting diode (LD) may be configured to emit light of one of the first, second, and third colors.

In some embodiments, the voltage of the first power line (ELVDD) may be greater than the voltage of the second power line (ELVSS). However, in special circumstances, such as to prevent or reduce light emission from the light-emitting diode (LD), the voltage of the second power line (ELVSS) may be set to be greater than the voltage of the first power line (ELVDD).

The sensing channel 151 may include a first switch (SW1), a second switch (SW2), and a sensing capacitor (Css).

A first electrode of the first switch (SW1) may be connected to a third node (N3). For example, the third node (N3) may correspond to the sensing line (Ik). A second electrode of the first switch (SW1) may receive an initialization voltage (Vint). For example, the second electrode of the first switch (SW1) may be connected to an initialization power supply which supplies the initialization voltage (Vint).

The first electrode of the second switch (SW2) may be connected to the third node (N3), and the second electrode may be connected to a fourth node (N4).

The sensing capacitor (Css) may have a first electrode connected to the fourth node (N4) and a second electrode connected to a reference power source (e.g., ground).

In some embodiments, the sensing unit 15 may include an analog-to-digital converter. For example, the sensing unit 15 may include analog-to-digital converters corresponding to the number of the sensing channels. The analog-to-digital converter may convert a sensing voltage stored in the sensing capacitor (Css) into a digital value. The converted digital value may be provided as sensing data to the timing controller 11. In some examples, the sensing unit 15 may include a smaller number of analog-to-digital converters than the sensing channels, and may convert sensing signals stored in the sensing channels in a time-division manner.

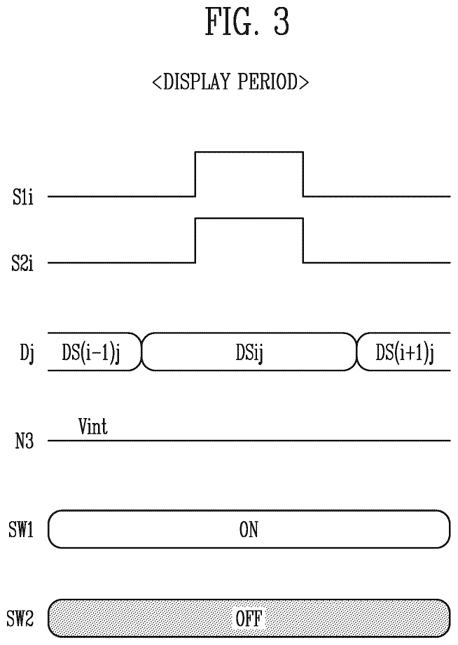

FIG. 3 is a drawing for illustrating a display period according to some embodiments of the present disclosure.

Referring to FIG. 3, during the display period, the sensing line (Ik), i.e., the third node (N3), may receive the initialization voltage (Vint). During the display period, the first switch (SW1) may be in a turn-on state, and the second switch (SW2) may be in a turn-off state.

During the display period, the data voltages (DS(i−1)j, DSij, DS(i+1)j) may be sequentially applied to the data line (Dj) in units of horizontal periods. A first scanning signal of a turn-on level (e.g., a logic high level) may be applied to the first scanning line (S1i) during the corresponding horizontal period. In addition, synchronized with the first scanning line (S1i), a second scanning signal of a turn-on level may also be applied to the second scanning line (S2i). In some embodiments, during the display period, the second scanning line (S2i) may always be in a state where the second scanning signal of the turn-on level is applied.

For example, when scanning signals of a turn-on level are applied to the first scanning line (S1i) and the second scanning line (S2i), the second transistor (T2) and third transistor (T3) may be in a turn-on state. Therefore, a voltage corresponding to a difference between the data voltage (DSij) and the initialization voltage (Vint) is written to the storage capacitor (Cst) of the pixel (SPij).

In the pixel (SPij), the amount of driving current flowing through a driving path connecting the first power line (ELVDD), the first transistor (T1), the light-emitting diode (LD), and the second power line (ELVSS) is determined according to a voltage difference between the gate electrode and the source electrode of the first transistor (T1). Depending on the amount of driving current, light-emitting luminance of the light-emitting diode (LD) may be determined.

Thereafter, when a scanning signal of a turn-off level (e.g., a logic low level) is applied to the first scan line (S1i) and the second scan line (S2i), the second transistor (T2) and the third transistor (T3) may be in a turn-off state. Thus, regardless of a voltage change of the data line (DJ), the voltage difference between the gate electrode and the source electrode of the first transistor (T1) may be maintained by the storage capacitor (Cst), and the light-emitting luminance of the light-emitting diode (LD) may be maintained.

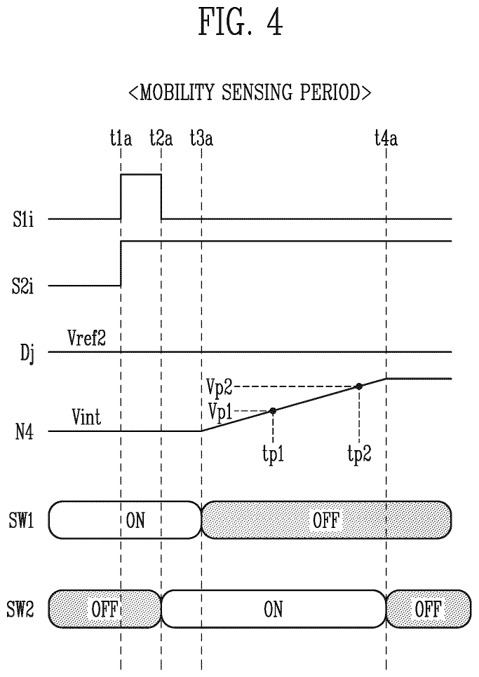

FIG. 4 is a diagram for illustrating a mobility sensing period according to some embodiments of the present disclosure.

At a time point (t1a), the first scanning signal of the turn-on level may be applied to the first scanning line (S1i), and the second scanning signal of the turn-on level may be applied to the second scanning line (S2i). At this time, since a reference voltage (Vref2) is applied to the data line (Dj), the reference voltage (Vref2) may be applied to the first node (N1). Further, since the first switch (SW1) is in the turn-on state, the initialization voltage (Vint) may be applied to the second node (N2) and the third node (N3). Accordingly, the first transistor (T1) may be turned on according to a difference between a gate voltage and a source voltage.

At a time point (t2a), as the first scanning signal of a turn-off level is applied to the first scanning line (S1i), the first node (N1) may be in a floating state. In addition, the second switch (SW2) may be turned on so that the initialization voltage (Vint) can be applied to the fourth node (N4).

At a time point (t3a), the first switch (SW1) may be turned off. Accordingly, as current is supplied from the first power line (ELVDD) through the first transistor (T1), the voltages of the second, third, and fourth nodes (N2, N3, N4) increase. At this time, since the first node N1 is in the floating state, the gate-source voltage difference of the first transistor (T1) may be maintained.

At a time point (t4a), the second switch (SW2) may be turned off. Accordingly, the sensing voltage is stored in the first electrode of the sensing capacitor (Css). The sensing current of the first transistor (T1) may be obtained using the following Equation 1.

I=C*(Vp2−Vp1)/(tp2−tp1) Equation 1

Here, I is the sensing current of the first transistor (T1), C is a capacitance of the sensing capacitor (Css), Vp2 is the sensing voltage at a time point (tp2), and Vp1 is the sensing voltage at a time point (tp1).

Assuming that a voltage slope of the fourth node (N4) between the time point (t3a) and the time point (t4a) is linear, the sensing voltage at the time point (t3a) and the sensing voltage at the time point (t4a) may be known, so the sensing current of the first transistor (T1) may be calculated. In addition, the mobility of the first transistor (T1) may be calculated using the calculated sensing current. For example, the greater the sensing current, the greater the mobility. For example, the magnitude of the mobility may be proportional to the magnitude of the sensing current.

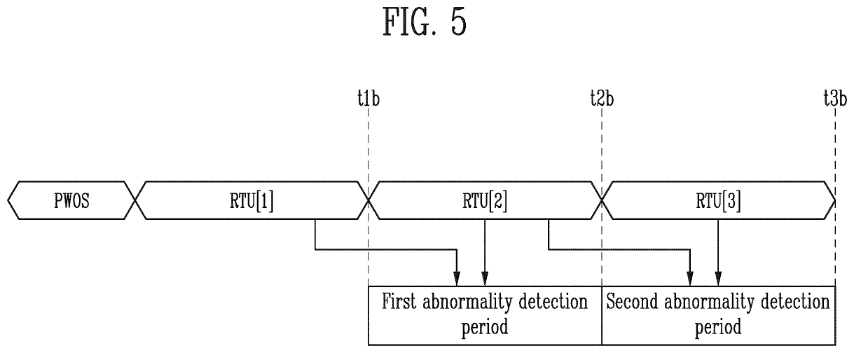

FIG. 5 is a drawing for illustrating periods of determining whether a display device is abnormal after a power-on sequence.

Referring to FIG. 5, after the power-on sequence (PWOS), mobilities of pixels (RTU[1]) may be sensed. The power-on sequence (PWOS) may be a series of necessary processes (or booting processes) to bring the display device (DD) from a power-off state to a usable state (i.e., a power-on state). A period during which the mobilities (RTU[1]) for all the pixels to be sensed of the pixel unit 14 are sensed for the first time may be called a first sensing frame period. That is, the first sensing frame period may include a period during which mobilities (RTU[1]) for all the pixels to be sensed of the pixel unit 14 are sensed for the first time.

At a time point (t1b), the mobilities of the pixels (RTU[2]) may be sensed. A period during which the mobilities (RTU[2]) for all the pixels to be sensed of the pixel unit 14 are sensed for the second time may be called a second sensing frame period (t1b˜t2b). That is, the second sensing frame period may include a period during which the mobilities (RTU[2]) for all the pixels to be sensed of the pixel unit 14 are sensed for the second time.

The abnormality detector 17 may determine whether the display device (DD) is abnormal based on difference values between the mobilities of the current sensing frame period and the mobilities of the previous sensing frame period. For example, the abnormality detector 17 may determine whether the display device (DD) is abnormal based on the difference values of the mobilities (RTU[2]) of the second sensing frame period (t1b˜t2b) and the mobilities (RTU[1]) of the first sensing frame period during a first abnormality detection period (t1b˜t2b). Similarly, the abnormality detector 17 may determine whether the display device (DD) is abnormal based on the difference values of the mobilities (RTU[3]) of the third sensing frame period (t2b˜t3b) and the mobilities (RTU[2]) of the second sensing frame period during a second abnormality detection period (t2b˜t3b).

At this time, the abnormality detector 17 may not be able to determine whether the display device (DD) is abnormal before the time point (t1b). Therefore, a display device and a method of driving the same are required or desired which is capable of relatively quickly detecting whether the display device (DD) is abnormal after the power-on sequence (PWOS).

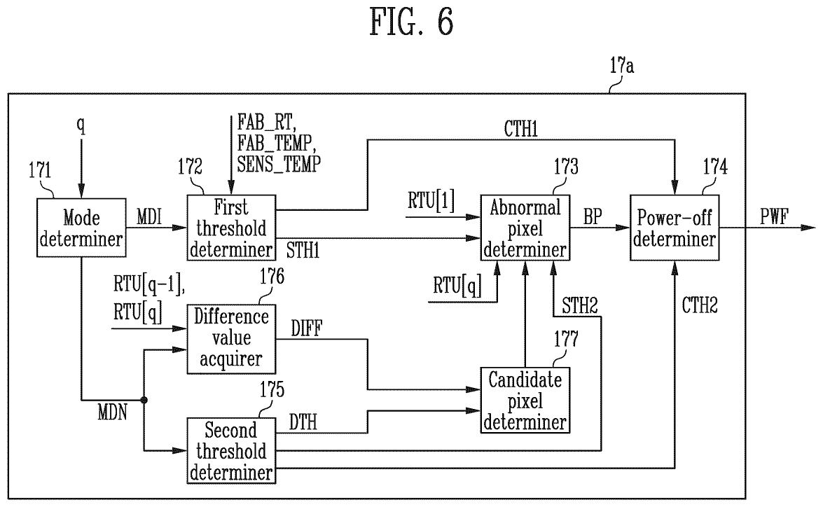

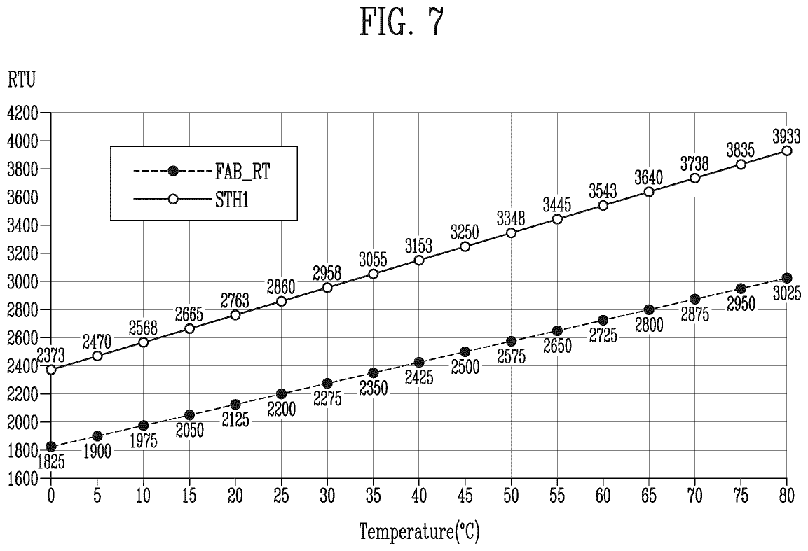

FIG. 6 is a diagram for illustrating an abnormality detector according to some embodiments of the present disclosure. FIG. 7 is a diagram for illustrating a first threshold determiner according to some embodiments of the present disclosure.

Referring to FIG. 6, an abnormality detector 17a according to some embodiments of the present disclosure may include a mode determiner 171, a first threshold determiner 172, an abnormal pixel determiner 173, a power-off determiner 174, a second threshold determiner 175, a difference value acquirer 176, and a candidate pixel determiner 177.

The abnormality detector 17a may determine whether the display device (DD) is abnormal based on a current temperature (SENS_TEMP) and the mobilities (RTU[1]) during the first sensing frame period after the power-on sequence. The abnormality detector 17a may determine whether the display device (DD) is abnormal based on difference values (DIFF) of the mobilities of the current sensing frame period (RTU[q]) and the mobilities of the previous sensing frame period (RTU[q−1]) during the sensing frame periods after the first sensing frame period.

The mode determiner 171 may determine whether the current sensing frame period corresponds to the first sensing frame period or a sensing frame period after the first sensing frame period. For example, the mode determiner 171 may determine which sensing frame period the current sensing frame period is after the power-on sequence (PWOS). For example, the mode determiner 171 may determine that the current sensing frame period is the q-th sensing frame period. For example, the mode determiner 171 may generate a variable q by including a counter within itself, or receive a variable q from an external counter. Here, q may be an integer greater than zero (0).

The mode determiner 171 may provide a first mode signal (MDI) if q is 1. The first-mode signal (MDI) may indicate that the current sensing frame period is the first sensing frame period after the power-on sequence (PWOS). At this time, the abnormality detector 17a may operate in a first mode.

The mode determiner 171 may provide a second mode signal (MDN) if q is an integer greater than 1. The second mode signal (MDN) may indicate that the current sensing frame period is a sensing frame period after the first sensing frame period. At this time, the abnormality detector 17a may operate in a second mode.

The first threshold determiner 172 may determine a first threshold (STH1) based on a reference mobility (FAB_RT), a reference temperature (FAB_TEMP), and the current temperature (SENS_TEMP) in the case that the current sensing frame period corresponds to the first sensing frame period (i.e., the first mode). For example, the first threshold determiner 172 may determine the first threshold (STH1) to be larger as the current temperature (SENS_TEMP) increases (see FIG. 7 and Equation 2).

STH1=[TC*(SENS_TEMP−FAB_TEMP)+FAB_RT]*MG Equation 2

Here, STH1 may be the first threshold (STH1), TC may be a temperature coefficient (e.g., a predetermined temperature coefficient), SENS_TEMP may be the current temperature (SENS_TEMP) provided by the temperature sensor 16, FAB_TEMP may be the reference temperature (FAB_TEMP) which is the temperature at the time of manufacturing the display device (DD), FAB_RT may be the reference mobility (FAB_RT) which is the mobility at the time of manufacturing the display device (DD), and MG may be a margin ratio (e.g., a predetermined margin ratio).

In one or more embodiments, the reference mobility (FAB_RT) may be an average value of the mobilities of the pixels at the time of manufacturing the display device (DD). In this case, the first threshold determiner 172 may provide one first threshold (STH1) for a plurality of pixels. In some embodiments, the reference mobility (FAB_RT) may be a value of each of the mobilities of the pixels at the time of manufacturing the display device (DD). In this case, the first threshold determiner 172 may provide a plurality of first thresholds (STH1) for a plurality of pixels.

Referring to FIG. 7, a graph of mobility (RTU) versus temperature is illustrated as an example. The value of the mobility (RTU) on the graph is expressed as a digital value (i.e., a sensing code), and its specific value may vary depending on the type of display device (DD).

Referring to FIG. 7, it can be seen that the reference mobility (FAB_RT) increases as the temperature increases. In addition, it can be seen that the first threshold (STH1) increases as the temperature increases. At each temperature, the first threshold (STH1) may be set greater than the reference mobility (FAB_RT). The graph in FIG. 7 provides an example where the temperature coefficient (TC) of Equation 2 is set to 15 and the margin ratio (MG) is set to 1.3. For example, the reference temperature (FAB_TEMP) may be set to 25 degrees, and the reference mobility (FAB_RT) may be set to 2200.

The abnormal pixel determiner 173 may, in the first mode, determine abnormal pixels (BP) among the pixels based on the first threshold (STH1) and the mobilities (RTU[1]) of the first sensing frame period. For example, the abnormal pixel determiner 173 may determine the pixels corresponding to the mobilities (RTU[1]) greater than the first threshold (STH1) as the abnormal pixels (BP).

In the first mode, the first threshold determiner 172 may provide a reference number (CTH1). The reference number (CTH1) may be set differently depending on the type of display device (DD). For example, the reference number (CTH1) may be appropriately determined by the resolution of the pixel unit 14 of the display device (DD).

The power-off determiner 174 may determine power-off (PWF) of the display device (DD) if the number of the abnormal pixels (BP) is greater than the reference number (CTH1) in the first mode. That is, when the number of the number of the abnormal pixels (BP) is greater than the reference number (CTH1) in the first mode, the power-off determiner 174 may determine power-off (PWF) of the display device (DD).

The difference value acquirer 176 may, in the second mode, acquire difference values (DIFF) between the mobilities (RTU[q]) of the current sensing frame period and the mobilities (RTU[q−1]) of the previous sensing frame period when the current sensing frame period corresponds to the sensing frame period (e.g., the q-th sensing frame period) after the first sensing frame period.

The second threshold determiner 175 may, in the second mode, provide a reference difference value (DTH), a second threshold (STH2), and a reference number (CTH2). The reference difference value (DTH), the second threshold (STH2), and the reference value (CTH2) may be predetermined and may be set differently depending on the type of display device (DD). For example, the reference number (CTH2) may be set to be the same as the reference number (CTH1).

The candidate pixel determiner 177 may, in the second mode, determine the pixels corresponding to the difference values (DIFF) greater than the reference difference value (DTH) as candidate pixels (BPC).

The abnormal pixel determiner 173 may, in the second mode, determine the abnormal pixels (BP) among the candidate pixels (BPC) based on the mobilities (RTU[q]) corresponding to the candidate pixels (BPC) and the second threshold (STH2). For example, the abnormal pixel determiner 173 may determine the candidate pixels (BPCs) corresponding to mobilities (RTU[q]) greater than the second threshold (STH2) as the abnormal pixels (BP).

The power-off determiner 174 may, in the second mode, determine the power-off (PWF) of the display device (DD) when the number of the abnormal pixels (BP) is greater than the reference number (CTH2).

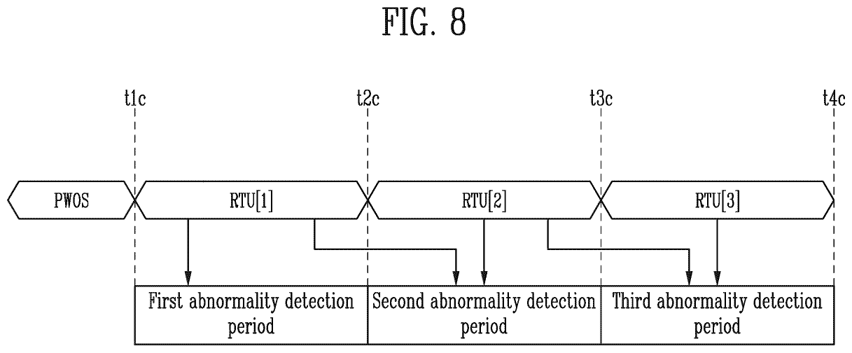

FIG. 8 is a diagram for illustrating periods of determining whether the display device is abnormal after the power-on sequence according to aspects shown in FIG. 7.

Referring to FIG. 8, after the power-on sequence (PWOS), the mobilities of the pixels (RTU[1]) during a first sensing frame period (t1c˜t2c) may be sensed. For all the pixels of the pixel unit 14 to be sensed, the period during which the mobilities (RTU[1]) are sensed for the first time may be called the first sensing frame period (t1c˜t2c).

According to the embodiment of FIG. 7, during the first sensing frame period (t1c˜t2c), the abnormality detector 17a may operate in the first mode. Therefore, even if there is no other sensing frame period before the first sensing frame period (t1c˜t2c), it is possible to generate the first threshold (STH1). Therefore, it is possible to detect whether the display device (DD) is abnormal during the first sensing frame period (t1c˜t2c). For example, the abnormality detector 17a may determine whether the display device (DD) is abnormal based on the current temperature and the mobilities (RTU[1]) in the first sensing frame period (t1c˜t2c) after the power-on sequence (PWOS). Accordingly, the display device (DD) according to the present disclosure and a driving method thereof may quickly detect whether the display device (DD) is abnormal after the power-on sequence (PWOS).

During the sensing frame periods after the time point (t2c), the abnormality detector 17a may operate in the second mode. For example, in a second sensing frame period (t2c˜t3c), the abnormality detector 17a may determine whether the display device (DD) is abnormal based on the difference values between the mobilities of the current sensing frame period (RTU[2]) and the mobilities of the previous sensing frame period (RTU[1]). In addition, in a third sensing frame period (t3c˜t4c), the abnormality detector 17a may determine whether the display device (DD) is abnormal based on the difference values between the mobilities of the current sensing frame period (RTU[3]) and the mobilities of the previous sensing frame period (RTU[2]).

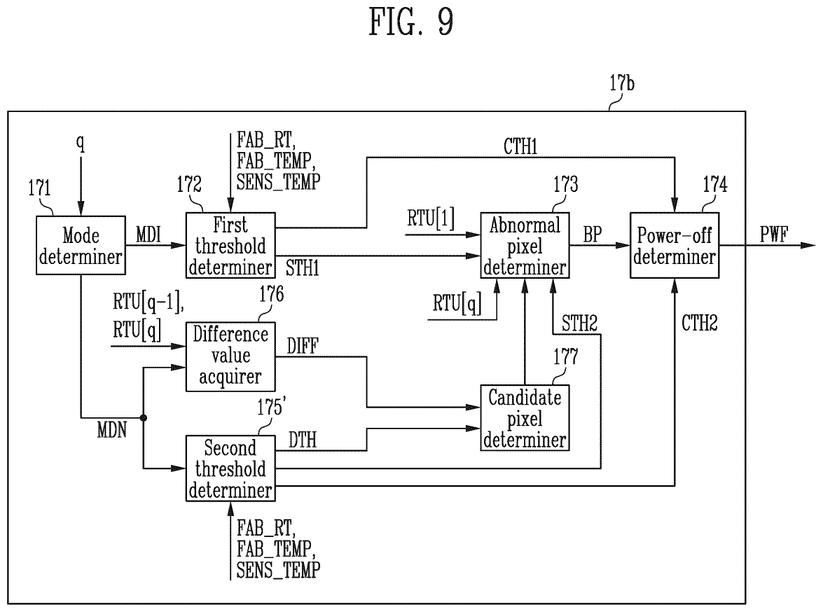

FIG. 9 is a drawing for illustrating an abnormality detector according to some embodiments of the present disclosure.

An abnormality detector 17b of FIG. 9 may include a second threshold determiner 175′. Since the other configuration of the abnormality detector 17b of FIG. 9 is the same as that of the abnormality detector 17a of FIG. 6, redundant illustration is not provided.

The second threshold determiner 175′ may determine the second threshold (STH2) based on the reference mobility (FAB_RT), the reference temperature (FAB_TEMP), and the current temperature (SENS_TEMP) when the current sensing frame period corresponds to the sensing frame period after the first sensing frame period (i.e., the second mode). For example, the second threshold determiner 175′ may determine the second threshold (STH2) to be greater as the current temperature (SENS_TEMP) increases. For example, the second threshold (STH2) may be determined in the same way as the first threshold (STH1) in Equation 2.

According to some embodiments of the present disclosure, even if the mobility increases in a high-temperature environment, as the first threshold (STH1) and the second threshold (STH2) increase together, false or inaccurate judgment of the abnormality of the display device (DD) may be reduced.

A display device according to an embodiment is applicable to various types of electronic devices. In an embodiment, an electronic device includes the above-described display device and may further include other modules or devices having additional functions in addition to the display device.

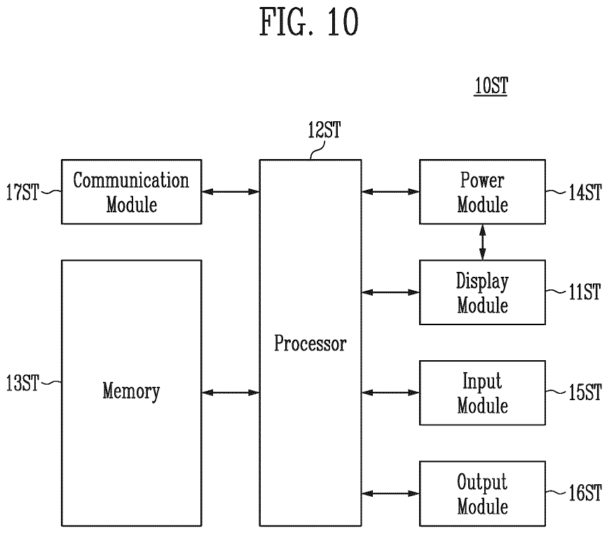

FIG. 10 is a block diagram of an electronic device according to an embodiment. Referring to FIG. 10, the electronic device 10ST may include a display module 11ST, a processor 12ST, a memory 13ST, and a power module 14ST.

The processor 12ST may include at least one of a central processing unit (CPU), an application processor (AP), a graphic processing unit (GPU), a communication processor (CP), an image signal processor (ISP), and a controller. In an embodiment, the processor 12ST may be divided into two or more parts from a functional or structural perspective. For example, the processor 12ST includes a main processor in the form of a first driving chip including a CPU and an auxiliary processor in the form of a second driving chip. The auxiliary processor may include a controller that receives image data signals from the main processor and processes the image data signals to conform to interface specifications of the display module 11ST. The processor 12ST may provide input image data. The display module 11ST may display an image based on the input image data.

The memory 13ST may include at least one of a non-volatile memory and a volatile memory. The memory 13ST may store data and/or information used to operate the processor 12ST or the display module 11ST. When the processor 12ST executes an application stored in the memory 13ST, image data signals and/or input control signals may be transferred to the display module 11ST. The display module 11ST may process the provided signals and output image information on a display screen.

The power module 14ST may include a power supply module, such as a power adapter or a battery device, and a power conversion module. The power conversion module converts power supplied by the power supply module and generates power to operate the electronic device 10ST. Power conversion performed by the power conversion module may include DC-DC conversion, AC-AC conversion, and DC-AC conversion, but embodiments are not limited thereto.

The electronic device 10ST may further include an input module 15ST, a non-image output module 16ST, and/or a communication module 17ST.

The input module 15ST may provide input information to the processor 12ST and/or the display module 11ST. The input module 15ST may include not only a physical button, a keyboard, and a microphone, but also various kinds of sensor modules. Examples of the sensor modules may include a biometric sensor, such as a blood pressure sensor, a blood glucose sensor, an electrocardiogram sensor, and a heart rate sensor, as well as a touch sensor, a pressure sensor, a distance sensor, a position sensor, a digitizer, a motion recognition sensor, a camera sensor (an image sensor), a light receiving sensor, a photoelectric conversion sensor, and a temperature sensor.

The non-image output module 16ST may receive information other than image information from the processor 12ST and provide the information to a user. Examples of the non-image output module 16ST may include an audio module, a haptic module, a light emitting module, and unique functional modules of the electronic device such as a cooling module of a refrigerator.

The communication module 17ST may serve to facilitate information exchange between the electronic device 10ST and an external device, and may include a transmitter and a receiver. The communication module 17ST may include various types of wireless communication modules such as a mobile communication module, a WiFi module, and a Bluetooth module, or various kinds of wired communication modules.

At least one of the above-described components of the electronic device 10ST may be included in the display device according to embodiments as described above. In addition, in terms of functionality, some of the individual modules included in one module may be included in a display device and others may be provided separately from the display device. For example, the display module 11ST is included in the display device, whereas the processor 12ST, the memory 13ST, and the power module 14ST are not included in the display device and are instead provided separately in the electronic device 10ST. In another example, the display device further includes the power module 14ST and the power module 14ST supplies power to the processor 12ST and the memory 13ST that are provided separately from the display device in the electronic device 10ST. However, embodiments are not limited to this example.

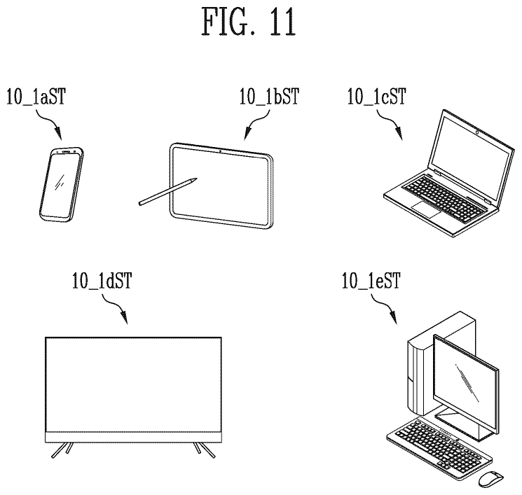

FIGS. 11 to 13 shows schematic views of various embodiments of an electronic device. FIGS. 11 to 13 illustrate examples of various types of electronic devices to which embodiments of a display device are applied.

FIG. 11 shows a smartphone 10_1aST, a tablet PC 10_1bST, a laptop computer 10_1cST, a television (TV) 10_1dST, and a desktop monitor 10_1eST as examples of the electronic device 10ST.

The smartphone 10_1aST may include an input module, such as a touch sensor, and a communication module in addition to the display module 11ST. The smartphone 10_1aST may process information received through the communication module or the input module and display the processed information on the display module of the display device.

Similarly to the smartphone 10_1aST, the tablet PC 10_1bST, the laptop computer 10_1cST, the television (TV) 10_1dST, and the desktop monitor 10_1eST may each include a display module and an input module and further include a communication module in some embodiments.

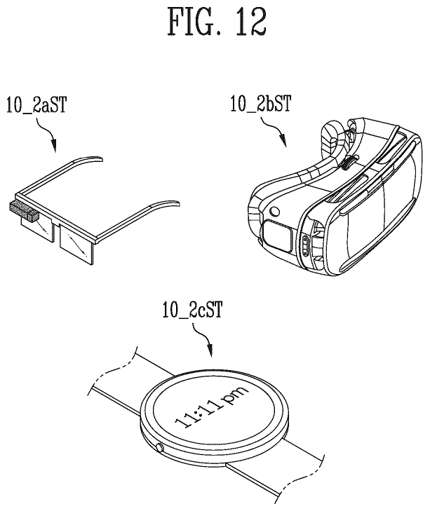

FIG. 12 shows examples in which the electronic device 10ST including the display module 11ST is applied to a wearable electronic device. The examples of the wearable electronic device may include smart glasses 10_2aST, a head-mounted display (HMD) 10_2bST, and a smart watch 10_2cST.

The smart glasses 10_2aST and the head-mounted display 10_2bST may each include a display module that projects a display image and a reflector that reflects the projected display image to direct it to the user's eyes, thereby providing the user with a virtual reality or augmented reality screen.

The smart watch 10_2cST may include a biometric sensor as an input device and provide biometric information detected by the biometric sensor to the user through a display module.

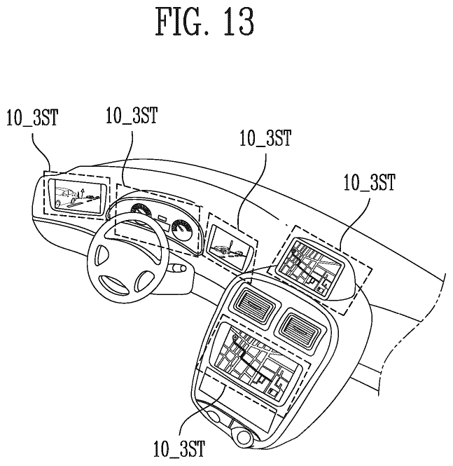

FIG. 13 shows an example in which the electronic device 10ST including the display module 11ST is applied to various kinds of an automotive electronic device 10_3ST. For example, the automotive electronic device 10_3ST is applied to a center information display (CID), which may be employed in the instrument cluster or the center fascia of the vehicle or disposed at the dashboard of the vehicle. The automotive electronic device 10_3ST may also be applied to a room mirror display replacing side mirrors.

Though not shown in FIG. 13, examples of electronic devices to which embodiments of a display device are applied may include various home appliances which display information on display modules, such as refrigerators, washing machines, dryers, air conditioners, and robot vacuum cleaners, as well as devices aimed at displaying screens, such as billboards, electronic display boards, and game consoles. In addition, when a display module has a function of transmitting light, the display module may be applied to an electronic device such as a smart window or a transparent display device which displays a background and a display image together. However, the types of an electronic device according to an embodiment are not limited to the above-described examples, and other various types of electronic devices are applicable.

The drawings and detailed description of the present disclosure described so far are merely examples of the present disclosure, and are used merely for the purpose of explaining the present disclosure and are not intended to limit the meaning or the scope of the present disclosure described in the claims. Therefore, those skilled in the art will appreciate that one or more suitable modifications and some equivalent embodiments are possible from this. Accordingly, the true scope of technical protection of the present disclosure should be determined by the technical idea of the appended claims, and their equivalents.

What is claimed is:

1. A display device comprising:
pixels;
a sensing unit configured to sense mobilities of the pixels during a sensing frame period;
a temperature sensor configured to measure a current temperature; and
an abnormality detector configured to determine whether the display device is abnormal based on the mobilities and configured to power off the display device based on an abnormality being detected,
wherein the abnormality detector is configured to determine whether the display device is abnormal based on the current temperature and the mobilities during a first sensing frame period after a power-on sequence.

2. The display device according to claim 1, wherein the abnormality detector is configured to determine whether the display device is abnormal based on difference values of the mobilities of a current sensing frame period and the mobilities of a previous sensing frame period, during sensing frame periods after the first sensing frame period.

3. The display device according to claim 2, wherein the abnormality detector comprises a mode determiner configured to determine whether the current sensing frame period corresponds to the first sensing frame period or a sensing frame period after the first sensing frame period.

4. The display device according to claim 3, wherein the abnormality detector further comprises a first threshold determiner configured to determine a first threshold based on a reference mobility, a reference temperature, and the current temperature, based on the current sensing frame period corresponding to the first sensing frame period.

5. The display device according to claim 4, wherein the abnormality detector further comprises an abnormal pixel determiner configured to determine abnormal pixels among the pixels based on the first threshold and the mobilities of the first sensing frame period.

6. The display device according to claim 5, wherein the abnormality detector further comprises a power-off determiner configured to determine power-off of the display device based on a number of the abnormal pixels being greater than a reference number.

7. The display device according to claim 6, wherein the abnormality detector further comprises a difference value acquirer configured to acquire difference values between the mobilities of the current sensing frame period and the mobilities of the previous sensing frame period, based on the current sensing frame period corresponding to a sensing frame period after the first sensing frame period.

8. The display device according to claim 7, wherein the abnormality detector further comprises a candidate pixel determiner configured to determine pixels corresponding to the difference values greater than a reference difference value as candidate pixels.

9. The display device according to claim 8, wherein the abnormal pixel determiner is configured to determine the abnormal pixels among the candidate pixels based on the mobilities corresponding to the candidate pixels and a second threshold.

10. The display device according to claim 9, wherein the abnormality detector further comprises a second threshold determiner configured to determine the second threshold based on the reference mobility, the reference temperature, and the current temperature, based on the current sensing frame period corresponding to a sensing frame period after the first sensing frame period.

11. A method of driving a display device, the method comprising:
measuring a current temperature;
sensing mobilities of pixels during a sensing frame period;
determining whether the display device is abnormal based on the mobilities; and
powering off the display device based on an abnormality of the display device being detected,
wherein whether the display device is determined to be abnormal is based on the current temperature and the mobilities during a first sensing frame period after a power-on sequence of the display device.

12. The method according to claim 11, wherein whether the display device is determined to be abnormal is based on difference values of the mobilities of a current sensing frame period and the mobilities of a previous sensing frame period during sensing frame periods after the first sensing frame period.

13. The method according to claim 12, further comprising determining whether the current sensing frame period corresponds to the first sensing frame period or a sensing frame period after the first sensing frame period.

14. The method according to claim 13, further comprising determining a first threshold based on a reference mobility, a reference temperature, and the current temperature, based on the current sensing frame period corresponding to the first sensing frame period.

15. The method according to claim 14, further comprising determining abnormal pixels among the pixels based on the first threshold and the mobilities of the first sensing frame period.

16. The method according to claim 15, further comprising determining power-off of the display device based on a number of the abnormal pixels being greater than a reference number.

17. The method according to claim 16, further comprising acquiring difference values between the mobilities of the current sensing frame period and the mobilities of the previous sensing frame period, based on the current sensing frame period corresponding to a sensing frame period after the first sensing frame period.

18. The method according to claim 17, further comprising:
determining pixels corresponding to the difference values greater than a reference difference value as candidate pixels; and
determining the abnormal pixels among the candidate pixels based on the mobilities corresponding to the candidate pixels and a second threshold.

19. The method according to claim 18, further comprising determining the second threshold based on the reference mobility, the reference temperature, and the current temperature, based on the current sensing frame period corresponding to a sensing frame period after the first sensing frame period.

20. An electronic device comprising:
a processor configured to provide an image data; and
a display device configured to display an image based on the image data,
wherein the display device comprises:
pixels;
a sensing unit configured to sense mobilities of the pixels during a sensing frame period;
a temperature sensor configured to measure a current temperature; and
an abnormality detector configured to determine whether the display device is abnormal based on the mobilities and configured to power off the display device based on an abnormality being detected, and
wherein the abnormality detector is configured to determine whether the display device is abnormal based on the current temperature and the mobilities during a first sensing frame period after a power-on sequence.
